(19) United States
(12) Patent Application Publication
(10) Pub. No.: US 2014/0149142 A1
(43) Pub. Date: May 29, 2014

(54) Detection of Healthcare Insurance Claim Fraud in Connection with Multiple Patient Admissions

(71) Applicant: FAIR ISAAC CORPORATION, Minneapolis, MN (US)

(72) Inventors: Robin P, Bangalore (IN); Michael K. Tyler, San Diego, CA (US); Goutham Valeti, Mumbai (IN); Vivek Bhardwaj, Bangalore (IN)

(73) Assignee: FAIR ISAAC CORPORATION, Minneapolis, MN (US)

(21) Appl. No.: 13/689,709

(22) Filed: Nov. 29, 2012

(51) Int. Cl. G06F 19/00

(52) U.S. Cl. CPC G06F 19/328
USPC 705/3

(57) ABSTRACT

A scoring model is provided that is trained using historical patient readmission data. The scoring model is used to analyze patient insurance claim data for which patients were readmitted to a healthcare facility in order to characterize whether the corresponding insurance claims are potentially fraudulent or erroneous. Related techniques, apparatus, systems, and articles are also described.

### TECHNICAL FIELD

The subject matter described herein relates to techniques for detecting potential fraudulent or erroneous healthcare insurance claims relating to early discharge of patients prior to completing a recommended course of treatment typically performed during a single visit within a single healthcare facility.

### BACKGROUND

Healthcare fraud continues to be a growing problem in the United States and abroad. According to the Centers for Medicare and Medicaid Services (CMS), fraud schemes range from those perpetrated by individuals acting alone to broad-based activities by institutions or groups of individuals, sometimes employing sophisticated telemarketing and other promotional techniques to lure consumers into serving as the unwitting tools in the schemes. Annual healthcare expenditures continue to increase at rates exceeding inflation. Though the amount lost to healthcare fraud and abuse cannot be precisely quantified, the general consensus is that a significant percentage is paid to fraudulent or abusive claims. Many private insurers estimate the proportion of healthcare dollars lost to fraud to be in the range of 3-5%, which amounts to in excess of $100 billion annually. It is widely accepted that losses due to fraud and abuse are an enormous drain on both the public and private healthcare systems.

Most insurance providers use Prospective Payment System (PPS) for determining insurance payments. PPS is a method of reimbursement in which payment is made based on a predetermined, fixed amount. The payment amount for a particular service is derived based on the classification system of that service. In case of hospital inpatient services, PPS is based on diagnosis-related groups (DRG). The PPS mode of payment can be abused by unscrupulous actors. For instance, patients may be discharged early or shuttled between facilities without being treated properly. By discharging the patients early, hospitals benefit from the vacant beds which can be used for other new patients. In certain cases, the early discharged patients may get readmitted due to illness stemming from poor quality of care in the first episode, thus increasing the burden on the healthcare system.

### SUMMARY

In one aspect, data is received that characterizes a sequence of healthcare admissions for a patient. Such sequence comprising an initial admission to a first healthcare facility followed by at least one readmission to either the first healthcare facility or another healthcare facility. Each admission, in turn, comprising at least one healthcare insurance claim for healthcare insurance reimbursement. Thereafter, it is determined using at least one scoring model and historical patient readmission data that at least one of the healthcare insurance claims of the sequence is potentially fraudulent or erroneous. Based on such determination, data is subsequently provided that indicates that at least one of the healthcare insurance claims for the sequence is potentially fraudulent or erroneous based on the determination.

Providing data can include one or more of: displaying, transmitting, loading, or storing the data indicating that the healthcare insurance claim is potentially fraudulent or erroneous based on the determination

The sequence can be associated with one of a plurality of pre-defined diagnosis-related groups with each diagnosis-related group having a pre-defined historical readmission ratio. With such an implementation, the scoring model can use the readmission ratio as part of the determination.

The received data can include a length of stays for the initial admission and/or the subsequent admissions. Such length of stay information can be used to determine whether there is a deviation of the length of stay(s) from a pre-determined length of stay norm for the initial or corresponding admission. The scoring model can use such determined deviations for the determination.

In some variations, the received data comprises requested payment information for claims originating from the initial admission and/or one or more of the other admissions. In such cases, a deviation of the requested payment information from a pre-determined payment norm can be determined for the initial admission and/or other admissions. The scoring model can use such determined payment deviations in making the determination.

Gap intervals between admissions and/or a number of admissions (in the aggregate) can also be determined. Such information can also be used by the scoring model in making the determination.

An overall score can be determined for each healthcare facility that characterizes, for a population of historical patients, a likelihood that claims associated with readmissions are likely fraudulent or erroneous. With such variations, an output of the scoring model with the overall score can be weighted to result in an adjusted score.

In an interrelated aspect, data is received that characterizes a sequence of healthcare admissions for a patient. Such sequence comprising an initial admission to a first healthcare facility followed by at least one readmission to either the first healthcare facility or another healthcare facility. Each admission, in turn, comprising at least one healthcare insurance claim for healthcare insurance reimbursement. Thereafter, it is determined using at least one scoring model and historical patient readmission data that at least one of the healthcare insurance claims of the sequence is potentially fraudulent or erroneous. Based on such determination, data is subsequently provided that indicates that at least one of the healthcare insurance claims for the sequence is potentially fraudulent or erroneous based on the determination. The scoring model, in this implementation can use a function S=(A₁*A₂*A₃*A₄*A₅*A₆) in which: A₁ is a measurement of a likelihood of readmission for the sequence; A₂ is a measurement of deviation of a length of stay from a pre-determined norm for the initial admission; A₃ is a measurement of deviation of a length of stay from pre-determined norms for all admissions in the sequence; A₄ is a measurement of deviation of payment from a pre-determined norm for the initial admission; A₅ is a measurement of deviation of payment from pre-defined norms for all the admissions; A₆ is a measurement based on a gap in days between the admissions; and A₇ is a measurement based on a number of admissions in the sequence.

Computer program products are also described that comprise non-transitory computer readable media storing instructions, which when executed one or more data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the current subject matter allows determining potential fraud or errors derived from readmission of patients with certain conditions. In addition, the current subject matter is advantageous in that it provides a data driven method that adapts to the type of data it works on. This is important because the composition of the data may vary from payor to payor. In particular, Medicare data may be different from Medicaid because they cater to different strata of patients. Medicare data will have more claims related to diseases that affect old age whereas the Medicaid data may have a different spread overall. The current subject matter adapts to such differences in data sets.

The details of one or more variations of the subject matter described herein are set forth in the accompanying drawings and the description below. Other features and advantages of the subject matter described herein will be apparent from the description and drawings, and from the claims thereby avoiding the need to manually define rules.

### DESCRIPTION OF THE DRAWING

FIG. 1 is a process flow diagram illustrating a first technique for healthcare insurance claim fraud and error detection based on early patient readmission data.

### DETAILED DESCRIPTION

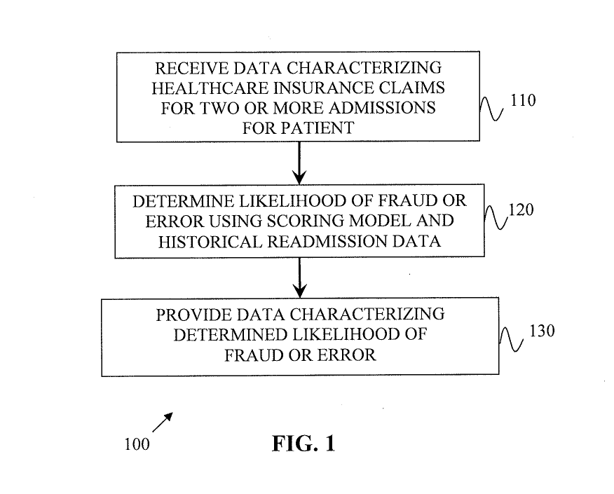

FIG. 1 is a process flow diagram illustrating a method 100, in which, at 110, data characterizing a sequence of healthcare admissions for a patient is received. The sequence comprises an initial admission to a first healthcare facility followed by at least one readmission to either the first healthcare facility or another healthcare facility. Each admission comprises at least one healthcare insurance claim for healthcare insurance reimbursement. Thereafter, at 120, it is determined, using at least one scoring model and historical patient readmission data, that at least one of the healthcare insurance claims of the sequence is potentially fraudulent or erroneous. Based on such determination, at 130, data indicating same can be provided (e.g., displayed, transmitted, loaded, stored, etc.).

As noted above, the current subject matter is directed to scoring facility claims prior to payment, and making such scores available for manual or automated review. The techniques described herein outline a way to highlight unusual cases of activity where the patient may have been given poor quality of care as evidenced by unnecessary readmissions.

Hospital inpatient claims being paid through the PPS mode make use of the diagnosis-related groups (DRG). DRG is a relatively broad condition and treatment definition that Medicare and other private payers use for reimbursement fees. There are many DRG systems—for example CMS-DRG, AP-DRG etc.

During design-time, DRGs can be combined to form coarser groups based on the similarities between DRGs. This can be achieved by making similarity matrices on the description of the DRG and the diagnosis codes associated with DRG in the historical data. One technique for forming such similarity groups is found in U.S. Pat. No. 8,219,415, the contents of which are hereby fully incorporated. Likelihood of readmission for each of these DRG groups can be computed using the historical data. One way in which it can be computed for each DRG group is by finding the ratio as:

$$\frac{Number of readmission episodes for the DRG group}{Total number of episodes for the DRG group}$$

The above ratio provides insight on what types of ailment may require frequent admissions or vice-versa. For example a patient may require more than one session of Chemotherapy. Table I below shows that there are far lesser episodes of readmission in case of Joint replacement than in case of Chemotherapy of Heart Failure.

TABLE I

| | Total number | Number of | Readmission |
|---|---|---|---|
| DRG GROUP | of admissions | readmissions | ratio |
| CHEMOTHERAPY | 1151 | 153 | 0.1329 |
| HEART FAILURE | 3167 | 182 | 0.0569 |
| & SHOCK | | | |
| PULMONARY DISEASE | 3940 | 189 | 0.0476 |
| SIMPLE PNEUMONIA | 2346 | 36 | 0.0152 |
| MULTIPLE MAJOR | 2596 | 3 | 0.0011 |
| JOINT OR LIMB | | | |
| REATTACHEMENT | | | |

Norms: Average and standard deviation of payment in dollars and/or length of stay in days (LOS) can be computed for each DRG from the historical data. These norms provide an indication whether the readmission was justified or not. For example a patient's treatment may be split between two facilities. In a genuine case, the cost is shared by the facilities and so the LOS and payment should be spilt too, resulting in lower than norm values.

Sequence: Sequences of claims for patients can be formed if there are readmissions within a specified period of time. Any one sequence can contain claims only for one patient and belongs to the same DRG group, not separated by more than a fixed number of days.

Scoring sequence:
Let:
A₁ be a measurement of a likelihood of readmission for the sequence (which can be based on the above-referenced ratio).
A₂ be a measurement of deviation of LOS from a norm for a first episode of a sequence. This can be a Z-value computation using computer norms.
A₃ be a measurement of deviation of LOS from norms for all episodes in the sequence. This value can be computed by using combined mean and standard deviations.
A₄ be a measurement of deviation of payment from a norm for the first episode of the sequence. This can be a Z-value computation using computed norms.
A₅ be a measurement of deviation of payment from norms for all the episodes in the sequence. This can be computed by using combined mean and standard deviations.
A₆ be a measurement based on a gap in days between the episodes. It could be an exponential decay function which would give more weightage to smaller gaps in the claims.
A₇ be a measurement based on a number of episodes in the sequence. It could be a value that would give more weight to a sequence which has more number of episodes.

For each sequence, some or all of the above A₁ to A₇ values are computed. These values can be used in a mathematical expression to arrive at a score for the sequence. One way to do it is to compute the percentiles for A₂ to A₅ The score of the sequence can then be computed as S=((percentile of A₄)+(percentile of A₅)+(100−percentile of A₃)+(100−percentile of A₂))*A₆ A₇. The above expression indicates that values of A₂ and A₃ are inversely proportional to the score, understandably as lower LOS would raise greater suspicion. Percentiles values for A₂ to A₅ needs to be computed on the historical data and stored as lookup values for scoring future batch of sequences. In some cases, the scores can be used as part of a scorecard model that differently weights each of the measurements. All the claims of the sequence can then be given the score of the sequence for better interpretation. In some cases, only a portion of the function S can be used to provide data characterizing one or more claims of the sequence (i.e., not all of the measures need to be determined or utilized).

Roll Up and Final Score: The above scores (S) can be rolled up to provider entity (i.e., the entity providing the services/tests specified by the claims, etc.). By rolling up such scores, providers frequently associated with sequences having high scores S can be identified. The roll up metric can then used to modulate the score S to arrive at the final score for the sequence. Fraudulent providers will have a high roll up metric and their sequences will in turn score higher due to this feedback mechanism.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figure and/or described herein do not require the particular order shown, or sequential order, to achieve desirable results. In addition, it will be appreciated that the techniques used herein may be used in connection with other non-healthcare claims or data structures in which variables may be extracted in order to determine whether such claim or data structure is atypical and requires additional review or analysis. Other embodiments may be within the scope of the following claims.

What is claimed is:

1. A non-transitory computer program product storing instructions that when executed by one or more data processors across at least one computing system result in operations comprising:
receiving data characterizing a sequence of healthcare admissions for a patient, the sequence comprising an initial admission to a first healthcare facility followed by at least one readmission to either the first healthcare facility or another healthcare facility, each admission comprising at least one healthcare insurance claim for healthcare insurance reimbursement;
determining, using at least one scoring model and historical patient readmission data, that at least one of the healthcare insurance claims of the sequence is potentially fraudulent or erroneous; and
providing data indicating that at least one of the healthcare insurance claims for the sequence is potentially fraudulent or erroneous based on the determination.

2. A computer program product as in claim 1, wherein providing data comprises one or more of: displaying, transmitting, loading, or storing the data indicating that the healthcare insurance claim is potentially fraudulent or erroneous based on the determination

3. A computer program product as in claim 1, further comprising:
associating the sequence with one of a plurality of pre-defined diagnosis-related groups, each diagnosis-related group having a pre-defined historical readmission ratio;
wherein the scoring model uses the readmission ratio as part of the determining.

4. A computer program product as in claim 1, wherein:
the received data comprises a length of stay for the initial admission;
the method further comprises: determining a deviation of the length of stay from a pre-determined length of stay norm for the initial admission and using, by the scoring model, the determined length of stay deviation for the initial admission.

5. A computer program product as in claim 1, wherein:
the received data comprises a length of stay for all admissions in the sequence;
the method further comprises: determining a deviation of the length of stay from a pre-determined length of stay norm for all of the admissions and using, by the scoring model, the determined length of stay deviations for all of the admissions.

6. A computer program product as in claim 1, wherein:
the received data comprises requested payment information for claims originating from the initial admission;
the method further comprises: determining a deviation of the requested payment information from a pre-determined payment norm for the initial admission and using, by the scoring model, the determined payment deviation for the initial admission.

7. A computer program product as in claim 1, wherein:
the received data comprises requested payment information for all claims originating from each admission;
the method further comprises: determining a deviation of the requested payment information from a pre-determined payment norm for each of the admissions and using, by the scoring model, the determined payment deviations for all of the admissions.

8. A computer program product as in claim 1, further comprising:
determining time gap intervals between the admissions and using, by the scoring model, the determined time gap intervals.

9. A computer program product as in claim 1, further comprising:
determining a total number of admissions and using, by the scoring model, the determined total number of admissions.

10. A computer program product as in claim 1, further comprising:
determining for each healthcare facility an overall score characterizing, for a population of historical patients, a likelihood that claims associated with readmissions are likely fraudulent or erroneous; and
weighting an output of the scoring model with the overall score to result in an adjusted score.

11. A method for implementation by one or more data processors forming part of at least one computing system, the method comprising:
receiving data characterizing a sequence of healthcare admissions for a patient, the sequence comprising an initial admission to a first healthcare facility followed by at least one readmission to either the first healthcare facility or another healthcare facility, each admission comprising at least one healthcare insurance claim for healthcare insurance reimbursement;
determining, using at least one scoring model and historical patient readmission data, that at least one of the healthcare insurance claims of the sequence is potentially fraudulent or erroneous; and
providing data indicating that at least one of the healthcare insurance claims for the sequence is potentially fraudulent or erroneous based on the determination.

12. A method as in claim 11, wherein providing data comprises one or more of:
displaying, transmitting, loading, or storing the data indicating that the healthcare insurance claim is potentially fraudulent or erroneous based on the determination

13. A method as in claim 11, further comprising:
associating the sequence with one of a plurality of pre-defined diagnosis-related groups, each diagnosis-related group having a pre-defined historical readmission ratio;
wherein the scoring model uses the readmission ratio as part of the determining.

14. A method as in claim 11, wherein:
the received data comprises a length of stay for the initial admission;
the method further comprises: determining a deviation of the length of stay from a pre-determined length of stay norm for the initial admission and using, by the scoring model, the determined length of stay deviation for the initial admission.

15. A method as in claim 11, wherein:
the received data comprises a length of stay for all admissions in the sequence;
the method further comprises: determining a deviation of the length of stay from a pre-determined length of stay norm for all of the admissions and using, by the scoring model, the determined length of stay deviations for all of the admissions.

16. A method as in claim 11, wherein:
the received data comprises requested payment information for claims originating from the initial admission;
the method further comprises: determining a deviation of the requested payment information from a pre-determined payment norm for the initial admission and using, by the scoring model, the determined payment deviation for the initial admission.

17. A method as in claim 11, wherein:
the received data comprises requested payment information for all claims originating from each admission;
the method further comprises: determining a deviation of the requested payment information from a pre-determined payment norm for each of the admissions and using, by the scoring model, the determined payment deviations for all of the admissions.

18. A method as in claim 11, further comprising:
determining time gap intervals between the admissions and using, by the scoring model, the determined time gap intervals.

19. A method as in claim 11, further comprising:
determining a total number of admissions and using, by the scoring model, the determined total number of admissions.

20. A computer program product as in claim 11, further comprising:
determining for each healthcare facility an overall score characterizing, for a population of historical patients, a likelihood that claims associated with readmissions are likely fraudulent or erroneous; and
weighting an output of the scoring model with the overall score to result in an adjusted score.

21. A computer-implemented method comprising:
receiving data characterizing a sequence of healthcare admissions for a patient, the sequence comprising an initial admission to a first healthcare facility followed by at least one readmission to either the first healthcare facility or another healthcare facility, each admission comprising at least one claim for healthcare insurance reimbursement;
determining, using at least one scoring model and historical patient readmission data, that at least one of the healthcare insurance claims of the sequence is potentially fraudulent or erroneous; and
providing data indicating that at least one of the healthcare insurance claims of the sequence is potentially fraudulent or erroneous based on the determination;
wherein the scoring model uses a function S=(A₁*A₂*A₃*A₄*A₅*A₆) in which:
A₁ is a measurement of a likelihood of readmission for the sequence;
A₂ is a measurement of deviation of a length of stay from a pre-determined norm for the initial admission;
A₃ is a measurement of deviation of a length of stay from pre-determined norms for all admissions in the sequence;
A₄ is a measurement of deviation of payment from a pre-determined norm for the initial admission;
A₅ is a measurement of deviation of payment from pre-defined norms for all the admissions;
A₆ is a measurement based on a gap in days between the admissions; and
A₇ is a measurement based on a number of admissions in the sequence.
